(19) United States
(12) Patent Application Publication
(10) Pub. No.: US 2002/0123866 A1
(43) Pub. Date: Sep. 5, 2002

(54) Optical proximity correction algorithm for pattern transfer

(76) Inventor: Benjamin Szu-Min Lin, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/754,220

(22) Filed: Jan. 5, 2001

(51) Int. Cl. G06F 17/10

(52) U.S. Cl. 703/2; 716/21

(57) ABSTRACT

An optical proximity correction algorithm using a computer aided design (CAD) system to eliminate the optical proximity effect when transferring the pattern of a photomask onto a wafer. The algorithm comprises, 1. providing an original layout to be formed on the semiconductor wafer, 2. analyzing the image condition of the original layout by the operation of a reverse Fourier transformation method on the original layout, and 3. creating a modified layout to be formed on the photomask according to the image condition.

### BACKGROUND OF THE INVENTION

1. Field of the Invention

The present invention relates to an optical proximity correction algorithm, and more particularly, to an optical proximity correction algorithm for the design of a photomask pattern in a semiconductor process.

2. Description of the Prior Art

In order to transfer an integrated circuit pattern onto a semiconductor wafer, a photomask must be fabricated according to the photomask design pattern, followed by the proportional transfer of the pattern of the photomask to a photoresist layer positioned on the semiconductor wafer.

Please refer to FIG. 1. FIG. 1 is a schematic diagram of a projection exposure process. As shown in FIG. 1, the projection exposure process uses a light source 10, such as ultra-violet light emitted from a mercury arc lamp, to project the pattern of a photomask 14 onto a photoresist layer 18 positioned on a semiconductor wafer 20. Light emitted from the light source 10 passes through a focus lens 12 to converge onto the photomask 14. In order to precisely project the pattern of the photomask 14 onto the photoresist layer 18, the projected light has to pass through a projective lens 16 to refocus onto the photoresist layer 18 and produce a latent pattern in the photoresist layer 18. A developing and etching process is subsequently performed to transfer the pattern of the photoresist layer 18 onto the semiconductor wafer 20.

As the design pattern of integrated circuits becomes smaller, diffraction becomes a more significant factor due to the projected light passing through smaller slits in the photomask pattern. This is called an optical proximity effect. The optical proximity effect will cause overexposure or underexposure at the corners of the pattern formed on the semiconductor wafer, to result in a resolution loss so that round profiles are formed at these corners to produce a corner rounding effect.

To prevent the optical proximity effect from causing a large difference in the pattern of the photomask from that formed on the semiconductor wafer, the common method of solution is to perform optical proximity corrections (OPC) on a photomask pattern via a computer aided design (CAD) system. Then, a pattern transfer is performed according to the corrected photomask pattern, eliminating the optical proximity effect.

Please refer to FIG. 2. FIG. 2 is a flow chart of a prior optical proximity correction algorithm. As shown in FIG. 2, the prior algorithm uses a CAD system to eliminate the optical proximity effect occurring during pattern transfer from the photomask to the semiconductor wafer. The prior algorithm comprises the following steps:

step 30: inputting an original layout of the photomask pattern to a computer memory via an input device;

step 32: inputting the light illumination conditions, such as numerical aperture (NA) of the lens, light source wavelength, exposure duration, photoresist thickness, developing conditions, etc.;

step 34: performing an optical program computation using a Fourier transformation method, to compute an exposure intensity affected on the photoresist layer when subjected to diffraction from the slits of the photomask pattern, with the equation of the method expressed as:

$$I = A \cdot {A}^{*} , A = {ⅇ}^{- iKb} [ \sqrt{\frac{λ b}{2}} {\int }_{E}^{} cos ( \frac{π}{2} {x}^{2} ) ⅆ x - i \sqrt{\frac{λ b}{2}} {\int }_{E}^{} sin ( \frac{π}{2} {x}^{2} ) ⅆ x ]$$

wherein I means the exposure intensity reaching the photoresist layer, A means the complex number amplitude when light reaches the photoresist layer, A^{*} means a conjugate complex number of A, E means the slit size in the photomask, b means the distance between the photomask and the photoresist, λ means the wavelength, x means the coordinate of some point in the photoresist, and K=2π/λ;

step 36: simulating a wafer pattern layout to be formed on the semiconductor wafer according to the exposure intensity computed from step 34;

step 38: comparing the wafer pattern layout simulated from step 36 with the photomask pattern layout stored in step 30 to identify if the two layouts correspond or if the comparing result is below a tolerance level, if correspond perform step 40a; if not, perform step 40b;

step 40a: outputting the photomask pattern layout via an output device;

step 40b: modifying the differences in the photomask pattern layout as identified in step 38, returning to step 30 to restore the modified photomask pattern layout in the memory, continuing the calculation loop while obeying the above steps until the wafer pattern layout is the same as the modified photomask pattern layout, and then outputting the modified photomask pattern layout.

The prior optical proximity correction algorithm repeats the computation loops, which is not only time-consuming, but also faces difficulty in modulating the complex physics and optics properties when modifying the different parts of the comparing results.

### SUMMARY OF THE INVENTION

It is therefore an object of the present invention to provide a more efficient optical proximity correction algorithm to solve the problems of the prior algorithm.

In a preferred embodiment, the present invention provides an optical proximity correction (OPC) algorithm using a computer aided design (CAD) system, to eliminate the optical proximity effect occurring during pattern transfer from a photomask onto a semiconductor wafer. The algorithm comprises, 1. providing an original layout to be formed on the semiconductor wafer, 2. analyzing the image condition of the original layout by the operation of a reverse Fourier transformation method on the original layout, and 3. creating a modified layout to be formed on the photomask according to the image condition.

It is an advantage of the present invention that an original layout to be formed on the semiconductor wafer, or the element pattern formed on the semiconductor wafer, is used to operate a reverse Fourier transformation method to reduce the modified photomask pattern layout before being affected by diffraction. As a result, the diffraction effect is eliminated when using the photomask pattern layout modified by the wafer pattern layout to perform a photolithographic process, and the element pattern formed on the photoresist layer of the semiconductor wafer is identical to that of the design.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a schematic diagram of a projection exposure process.

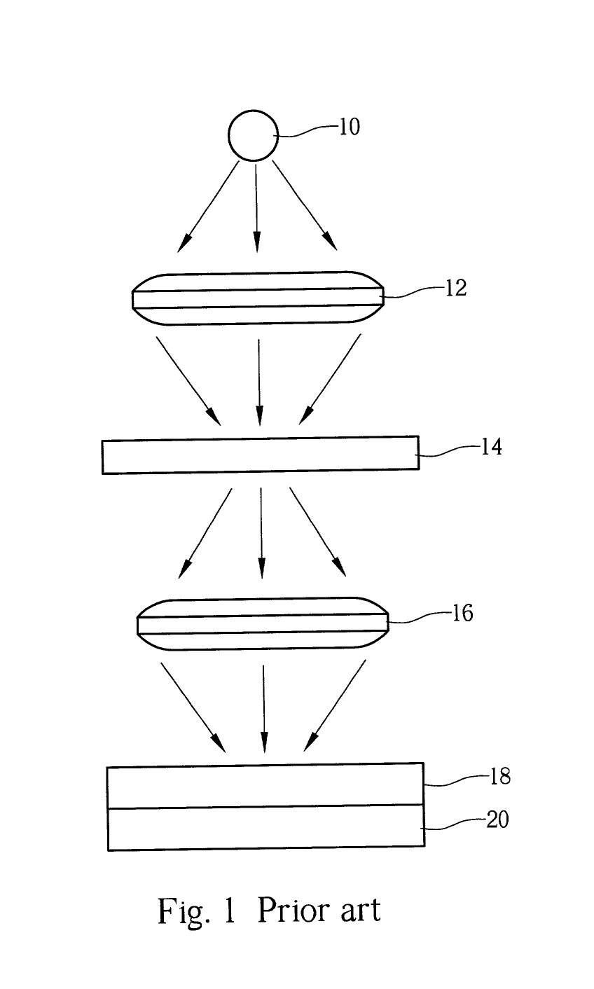

FIG. 2 is a flow chart of a prior optical proximity correction algorithm.

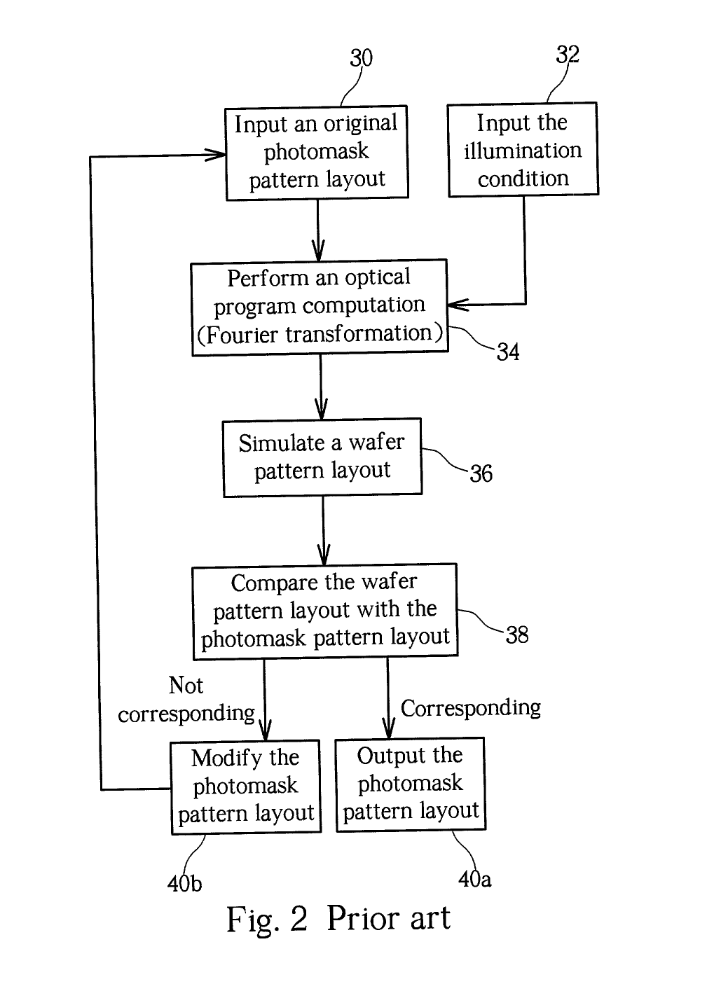

FIG. 3 is a flow chart of an optical proximity correction algorithm according to the present invention.

FIG. 4 is a flow chart of a second embodiment of the present invention optical proximity correction algorithm.

### DETAILED DESCRIPTION OF THE PREFERRED EMBODIMENT

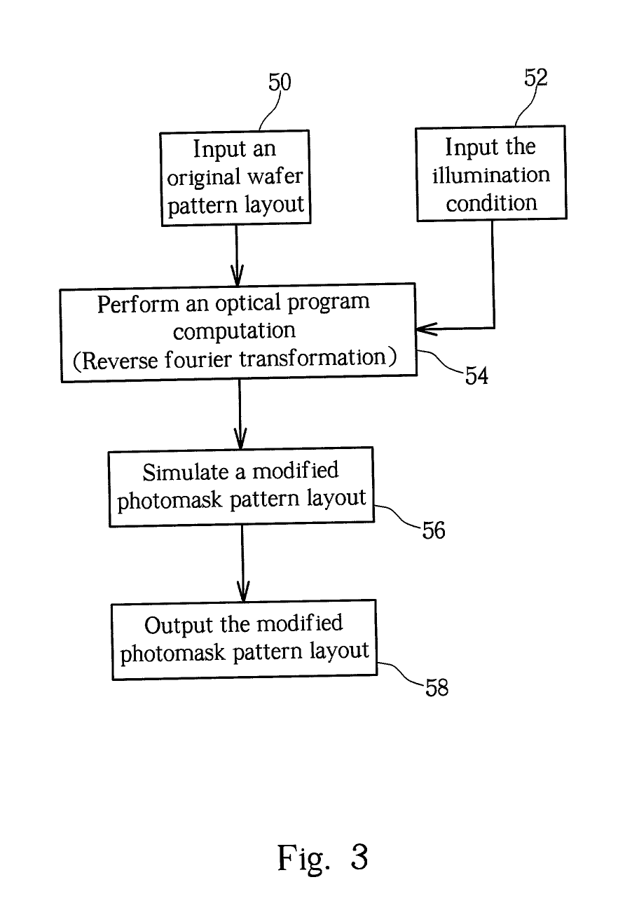

Please refer to FIG. 3. FIG. 3 is a flow chart of an optical proximity correction algorithm according to the present invention. As shown in FIG. 3, the present algorithm is primarily used in a computer aided design (CAD) system to eliminate the optical proximity effect occurring during pattern transfer from a photomask onto a semiconductor wafer. The method comprises the following steps:

step 50: inputting an original wafer pattern layout to a computer memory via an input device;

step 52: inputting the light illumination conditions, such as numerical aperture (NA) of the lens, light source wavelength, exposure duration, photoresist thickness, developing conditions, etc.;

step 54: performing an optical program computation, which uses a reverse Fourier transformation method to compute an exposure intensity reaching the photoresist layer according to the wafer pattern layout, whereby the exposure intensity is computed by integrating a Fourier transformation term over the slit geometry of the photomask pattern (as mentioned in step 34 of the prior art) so an image condition, such as slit geometry, is obtained by solving the integration equation after the exposure intensity is known;

step 56: simulating a modified photomask pattern layout according to the slit geometry computed from step 54;

step 58: outputting the modified photomask pattern layout using an output device.

According to the original wafer pattern layout (the element pattern), the present invention performs an optical program computation to reduce the modified photomask pattern layout before being affected by diffraction. The diffraction effect is thus eliminated when using the photomask pattern layout modified by the wafer pattern layout to perform a photolithographic process. Thus, an element pattern identical to that of the design is formed on the photoresist layer of the semiconductor wafer.

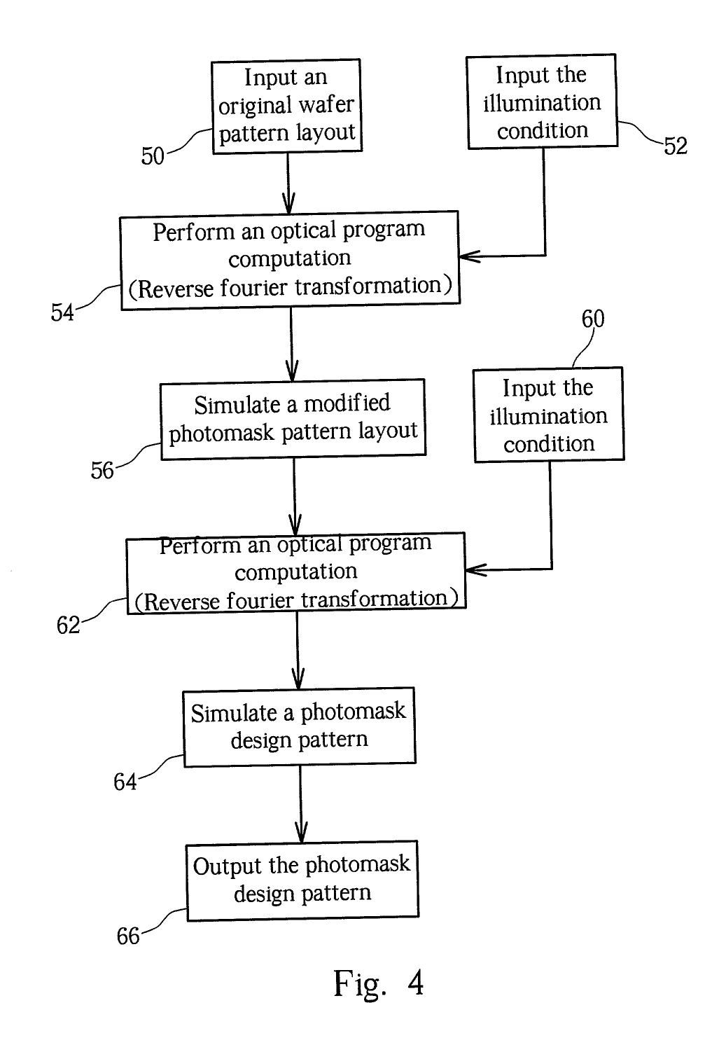

Please refer to FIG. 4. FIG. 4 is a flow chart of a second embodiment of the present invention optical proximity correction algorithm. This embodiment further considers the possibility of an optical proximity effect resulting from fabrication of the photomask by projection. As shown in FIG. 4, the embodiment further comprises the following steps after simulation of the modified photomask pattern layout in step 56:

step 60: inputting the light illumination conditions for fabricating the photomask, such as numerical aperture (NA) of lens, light source wavelength, exposure duration, photoactive properties of the photomask, developing conditions, etc.;

step 62: performing an optical program computation, using the simulated photomask pattern layout of step 56 to compute the exposure intensity reaching the photomask, and then computing the image condition, referring to the slit geometry in the photomask design pattern, for fabrication of the photomask by the photomask design pattern;

step 64: simulating the photomask design pattern according to the slit geometry computed from step 62;

step 66: outputting the photomask design pattern using an output device.

After the photomask design pattern is formed, a first photolithographic process is performed to produce the photomask by the transferring of the design pattern onto the photomask. Subsequently, a second photolithographic process is performed using the photomask to transfer its pattern onto the wafer to define the element position.

In contrast to the prior art, the present optical proximity correction algorithm uses the wafer pattern as an original layout to input into the memory. A reverse Fourier transformation method is also used to compute the slit geometry from the exposure intensity. In other words, the present invention uses the wafer pattern to reduce the photomask pattern, or uses the photomask pattern to reduce the photomask design pattern. Only one or two computation steps are needed to create a precise photomask pattern for the formation of a defined wafer pattern. Hence, repeated computation loops, comparison and modification of the photomask pattern are simplified, and resolution of the photolithography is improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An optical proximity correction (OPC) algorithm used in the photomask pattern design of a semiconductor process to reduce the optical proximity effect when transferring the photomask pattern from a photomask to the surface of a semiconductor wafer, the method comprising:
providing an original layout to be formed on the semiconductor wafer;
analyzing the image condition of the original layout by the operation of a reverse Fourier transformation on the original layout; and
creating a modified layout to be formed on the photomask according to the image condition;
wherein the modified layout is transferred from the photomask to the semiconductor wafer by a photolithographic process so that the semiconductor wafer produces a pattern the same as that of the original layout.

2. The method of claim 1 wherein the optical proximity correction algorithm is primarily used in a computer aided design (CAD) system.

3. The method of claim 1 wherein an exposure intensity of the original layout is computed using the reverse Fourier transformation method, followed by analysis of the image condition of the original layout according to the exposure intensity.

4. The method of claim 1 wherein the image condition refers to the slit geometry in the modified layout.

5. The method of claim 1 wherein a photoresist layer is positioned on the surface of the semiconductor wafer as a photoactive material.

6. An optical proximity correction algorithm used in the photomask pattern design of a semiconductor process, the method comprising:
providing an original layout to be formed on the semiconductor wafer;
performing a first reverse Fourier transformation method on the original layout to analyze the image condition of the original layout;
creating a modified layout to be formed on a photomask according to the image condition of the original layout;
performing a second reverse Fourier transformation method on the modified layout to analyze the image condition of the modified layout; and
creating a photomask design pattern according to the image condition of the modified layout;
wherein the photomask design pattern is used to fabricate a pattern on the photomask, followed by the transfer of the pattern on the photomask to a semiconductor wafer via a photolithographic process.

7. The method of claim 6 wherein the optical proximity correction algorithm is primarily used in a computer aided design (CAD) system.

8. The method of claim 6 wherein the original layout is inputted and stored in a computer memory via an input device.

9. The method of claim 6 wherein the reverse Fourier transformation method is operated via a computer central processing unit.

10. The method of claim 6 wherein both the first and second reverse Fourier transformation methods use the original layout or the modified layout to compute an exposure intensity, followed by the analysis of the image condition of the original layout or the modified layout according to the exposure intensity.

11. The method of claim 6 wherein the image condition of the original layout refers to the slit geometry in the modified layout while the image condition of the modified layout refers to the slit geometry in the photomask design pattern.

12. The method of claim 6 wherein a photoresist layer is positioned on the surface of the semiconductor wafer as a photoactive material.

13. A method of designing a photomask pattern comprising:
providing a defined pattern to be formed on the surface of a semiconductor wafer;
operating a reverse computation on the defined pattern to obtain the image condition composed of the defined pattern; and
designing the photomask pattern according to the image condition.

14. The method of claim 13 wherein the photomask pattern is used to fabricate a photomask, followed by the proportional transfer of the pattern on the photomask to the semiconductor wafer via a photolithographic process.

15. The method of claim 13 wherein the reverse computation comprises at least a reverse Fourier transformation method, which simulates the photomask pattern by analyzing the defined pattern on a semiconductor wafer.

16. The method of claim 13 wherein the image condition refers to the slit geometry in the photomask pattern.

17. The method of claim 13 wherein a photoresist layer is positioned on the surface of the semiconductor wafer as a photoactive material.
